(19) United States
(12) Patent Application Publication
(10) Pub. No.: US 2017/0099822 A1
(43) Pub. Date: Apr. 13, 2017

(54) Bladed fishing lure with depth determining mass

(71) Applicant: David L. Thorne, Kaysville, UT (US)

(72) Inventor: David L. Thorne, Kaysville, UT (US)

(21) Appl. No.: 15/330,534

(22) Filed: Oct. 4, 2016

Related U.S. Application Data
(63) Continuation-in-part of application No. 14/544,787, filed on Feb. 18, 2015.
Application No. 14/544,787 is a continuation-in-part of application No. 14/120,871, filed on Jul. 7, 2014.
Application No. 14/120,871 is a continuation-in-part of application No. 13/999,599, filed on Mar. 11, 2014, now Pat. No. 9,553,580.
Application No. 13/999,599 is a continuation of application No. 13/694,028, filed on Oct. 22, 2012, now Pat. No. 8,733,012.
Application No. 13/694,028 is a continuation-in-part of application No. 13/200,900, filed on Oct. 4, 2011, now Pat. No. 8,739,460.
Application No. 13/200,900 is a continuation-in-part of application No. 12/387,024, filed on Apr. 27, 2009, now Pat. No. 8,973,298.
Application No. 12/387,024 is a continuation-in-part of application No. 11/656,099, filed on Jan. 22, 2007, now abandoned.

(51) Int. Cl. A01K 85/12; A01K 85/16

(52) U.S. Cl. CPC A01K 85/12; A01K 85/16

(57) ABSTRACT

A plurality of bladed fishing lure embodiments having predetermined running depths dependent upon density characteristics of a stabilizing mass and mode of being affixed to a novel lure frame is disclosed. The blade is designed to translate blade oscillation into effective cyclic motion of an associated fishing lure assembly.

### CONTINUITY

This application is a Continuation-in-Part of U.S. patent application Ser. No. 14/544,787, titled FRAMES FOR BLADED AND WEIGHTED FISHING LURES and filed Feb. 18, 2015; which is a Continuation-in-Part of U.S. patent application Ser. No. 14/120,871, titled BLADED FISHING LURE and filed on Jul. 7, 2014; which is a Continuation-in-Part of patent application Ser. No. 13/999,599 titled LURE FISHING ASSEMBLY WITH WEIGHTED FRAME and filed Mar. 5, 2014; which is a Continuation of patent application Ser. No. 13/694.028, titled LURE FISHING ASSEMBLY WITH WEIGHTED FRAME and filed Oct. 22, 2012, now allowed as U.S. Pat. No. 8,733,012; which is a Continuation-in-Part of U.S. patent application Ser. No. 13/200,900, titled INTERCHANGEABLE BLADE AND LURE FISHING ASSEMBLY and filed Oct. 4, 2011, now allowed as U.S. Pat. No. 8,739,460; which is a Continuation-in-Part of U.S. patent application Ser. No. 12/387,024, titled BLADED FISHING LURE ASSEMBLY and filed Apr. 27, 2009, now allowed as U.S. Pat. No. 8,973,298; which is a Continuation-in-Part of U.S. patent application Ser. No. 11/656,099, titled FISHING LURE ASSEMBLY and filed Jan. 22, 2007, now abandoned, all of which are made part hereof by reference.

### FIELD OF INVENTION

This invention relates generally to fishing lures having various masses; in one embodiment having a floating mass being lighter than water and in another embodiment having a weighted or heavier than water mass, and more particularly to fishing lures that have a blade that oscillates and connecting frame and a rearward lure assembly on a trailing end and a stabilizing mass offset from a line connection on a forward end, such fishing lures being referenced herein as “depth determining” lures.

### BACKGROUND AND RELATED ART

There are many types of bladed fishing lures designed to attract fish. A fishing lure line connector is disclosed in U.S. Patent Application US 2013/0219770 by Inventor, James Ronald Davis (Davis). Davis discloses a fishing line connector having a single width and having a unitary elongated member shaped to form first and second eyelets at each member end. The line connector may be connected to a blade.

A snag-less fishing lure is disclosed in U.S. patent application US 2013/0047491 by Inventor, James Ronald Davis (Davis). Davis discloses a snag-less bladed lure having a blade that oscillates during retrieval and pitches forward to protect the hook from snagging upon encountering moss or other elements in the water. The fishing lure may include pitching means for pitching the blade relative to the hook. Further, the upper end of the blade oscillates side-to-side relative to a hook connector.

A snag resistant fishing lure is disclosed in U.S. Pat. No. 7,726,062 B2, issued Jun. 1, 2010 to James Ronald Davis (Davis). Davis discloses a jig with an attached blade. The jig has a weight molded about the shank of a hook with an eyelet disposed to maintain the sharpened point of a hook held upright by the relative dispositions of the eyelet, weight and orientation of the point. The blade is taught to be affixed to the eyelet, and to be limited in oscillation by either collision of the blade with the eyelet or with the weight to which it is directly affixed. Further, the blade is taught to comprise three holes, one of which is used to securely affix the blade to the eyelet. The other two holes are taught to be used in cooperation with a clip affixed to a fishing line for the purpose of releasibly affixing the fishing line of a fishing lure unit which comprises both blade and weighted fishing lure.

Wuensch et al., U.S. Pat. No. 8,028,465 B1, teaches a fishing lure and method of assembly comprising a lip, an eyelet extending forward of the lip. The eyelet being adapted to be attached to the fishing line for pulling the fishing lure through the water in a direction of movement towards the lip such that the lip imparts a movement to the fishing lure. Additionally, a buoyant or neutrally buoyant paddle extending from, and rigidly attached to the lip, having opposed side surfaces that together counterbalance the movement imparted by the lip. The invention includes a hook having a shank that is fixedly attached to and extends from the paddle.

Applicant believes that no fishing lure reference, disclosed, is the basis for a lure which is stabilized by a mass, offset from a line connection like the inventive lures disclosed herein.

### DEFINITIONS

For purposes of this disclosure, the following definitions apply:

aft, adv, near, toward, or in the rear of a lure away from a line of attachment.
blade, n, a broad flattened part which is affixed to a portion of a fishing lure and which oscillates as the lure is propelled in water to provide a wake following therefrom; such a blade may be rigid or flexible, if flexible such a blade requires a supporting mast to withstand pressure from being displaced through water.
centrally, adv, near, toward the center of gravity, syn: medially.
distal, adj, (see also proximal) indicates the segment of a device normally away from a line attachment of a lure.
fishhook, n, a device, usually made of rigid metal wire, comprising a curved section which has a sharpened point on one end for catching a fish and a shank which comprises a substantially straight portion on an opposite end. Generally, the shank is ultimately affixed with an eyelet and/or split ring to the lure or it may be directly and rigidly affixed to the back portion of the lure.
fishing lure assembly, n, a combination comprising a fishhook assembly and a bait which may be natural or artificial
fishhook assembly, n, a combination of a fishhook and other optional attributes associated with the fishhook for attaching the fishhook to a frame or frame and for adding attractive components such as an artificial or natural bait.
fore, adv, in, toward or adjacent to the front (i.e. forward) toward a line of attachment.
inferior, adj, situated lower down or closer to the center of the earth than a referenced site.
jig, n, a fishhook which has a weight affixed about an associated shank of the fishhook.
proximal, adj, indicates the segment of a device normally closely disposed relative to a line attachment of a lure.
shank, n, a frame which is a proximal portion of a fishhook the shank usually having a substantially straight portion which is associated with a curved portion of a fishhook and with a connecting link by which the fishhook is affixed to other fishing gear.
stabilizing mass, n: a mass disposed relative to a fishing line connection to provide in-water stability and, by density, lure running depth
substantially, adv,: having a similar form and function which does not materially depart from an ideal or perfect form of the referenced item (e.g. a ball my be considered to be substantially spherical while having minor deformities which cause it to be an imperfect relative to an ideal sphere, a form of which cannot be exactly achieved in “real” life)
superior, adj, situated higher up or away from the center of the earth relative to a referenced site.
yaw, n: oscillatory angular motion which is disposed about an axis subtending substantially orthogonally behind a blade of a lure.
vertical oscillation: oscillatory angular displacement which is substantially disposed about an axis determined by oscillation about an angle of attack of a blade

### BRIEF SUMMARY AND OBJECTS OF THE INVENTION

To be an effective fishing tool, a fishing lure should have reliable and predictable performance characteristics. As an example, casting properties of the lure should be accurate, precise and be able to be “thrown” an acceptable distance. Once in the water, the lure should be stable and perform predictably through a variety of fishing maneuvers without undo spinning, tangling or snagging and be depth determining. In the case of a lure made according to the present invention, an associated blade should produce a wake and frame yaw motion which results in life-like movement of a following affixed bait, whether artificial or natural, as disclosed in detail in U.S. Patent Applications from which this Application continues-in-part. Further, desired fishing depth parameters should be, at least, determined by lure design.

In brief summary, this invention is based upon a novel fishing lure frame and associated mass which stabilizes the lure in water and determines, in conjunction to a blade angle of attack, effective lure running depth relative to an attached fishing line. The mass may be buoyant (e.g. a bobber) or be more dense than water such as a metal weight, but displaced from the plane of attachment of a fishing line to provide in-water stability. Further, the fishing lure assembly comprises an oscillating blade and a fishing hook assembly disposed aft from the blade. The blade is positioned relative to the fishing line connection such that when drawn through the water, the blade oscillates side-to-side producing yaw motion in the associated frame and a effective bait affecting wake. The fishing lure assembly may include an affixed hook or loosely affixed hook such as a treble hook and may have natural or artificial bait connected to the hook. By the nature of hook attachment, the lure is effectively snag resistant when drawn behind the oscillating blade. In an embodiment where the mass is buoyant for shallow fishing, the mass may be “in-line” with the plane created by a superiorly extending frame segment preferably proximal to the line attachment site. In an embodiment where the mass is heavier than water for sinking for moderate depth fishing, the weight is positioned in-line along a straight frame segment extending forward from a distally positioned blade. Lures made according to the instant invention may have as few as four components (the fishhook assembly being counted as one component) and include novel frame features for ease of assembly with minimal threading when assembled to a blade designed for oscillation when drawn through water. The heavier than water mass is attached to the frame forwardly and in-line with the medially positioned blade-to-frame attachment site. The heavier than water mass also includes a superiorly positioned line attachment site located between the center of gravity and a site forward of the heavier than water mass. The preferred attachment site is superior to the mass and between the center of gravity and a site forward of the mass. The preferred line attachment site is forwardly disposed and superior to the most forward portion of the heavier than water mass.

The fishing lure may include a buoyant mass located superiorly to the line connection site. The buoyant mass fishing lure embodiment is also weed resistant resulting from the line connection site forward of the blade which is largely in-line with the fishing lure assembly. The fishhook assembly is the most rearward lure portion, followed in-line by the blade and then line connection site. Each of these components is connected preferably by a common frame. A superiorly extending frame connects the buoyant mass to the fishing lure assembly and the buoyant mass provides stability to the oscillating lure when drawn through water. Primary to the invention is the interaction of an oscillating blade and the frame to create a lateral side-to-side motion in the weighted lure body. The loosely, but securely attached oscillating blade, comes in contact with the frame and having sufficient mass creates a “hammer” effect during each oscillation, the resulting energy of the contact is transferred through the frame that is rigidly and securely attached to the weighted lure body to create a laterally opposing side-to-side rotary motion to the front and back portions of the weighted lure body.

It is a primary objective to provide a frame and mass combination which, in association with action of an oscillating blade has a predetermined running depth and orientation in water.

Another primary objective is to provide a fishing lure having an exaggerated motion relative to the motion of the weight.

It is an important object to provide a blade member that is securely, but pivotally affixed to the frame such that the blade is permitted to oscillate as the lure is displaced through water.

It is a major objective to provide a simplified method for connecting a blade to a frame and for amplified displacement of a hook assembly due to the oscillation of said blade.

It is another important object to provide a frame variance which permits off-line displacement of an associated stabilizing mass which determines running depth of the lure in water.

These and other objects and features of the present invention will be apparent from the detailed description taken with reference to accompanying drawings.

### BRIEF DESCRIPTION OF THE DRAWINGS

FIG. 1 is a side elevation of a fishing lure made according to the present invention with a bobber affixed to a wireframe for providing stability and level determination when the lure is drawn through water.

FIG. 2 is a perspective of the fishing lure seen in FIG. 1.

FIG. 3 is a side elevation of the fishing lure seen in FIG. 2 with a bait affixed to a hook assembly thereof.

FIG. 4 is a side elevation of a fishing lure made according to the present invention with a weighted part affixed to a frame of the lure being inferiorly disposed relative to a fishing line attachment site to provide lure stability in water and depth determining weight for the lure when drawn through water.

FIG. 5 is a top perspective of the lure seen in FIG. 5.

FIG. 6 is a side elevation of the fishing lure seen in FIG. 2 with a bait affixed to a hook assembly thereof.

FIG. 7 is a perspective of the fishing lure seen in FIG. 6.

These and other objects and features of the present invention will be apparent from the detailed description taken with reference to accompanying drawings.

### DETAILED DESCRIPTION OF THE ILLUSTRATED EMBODIMENTS

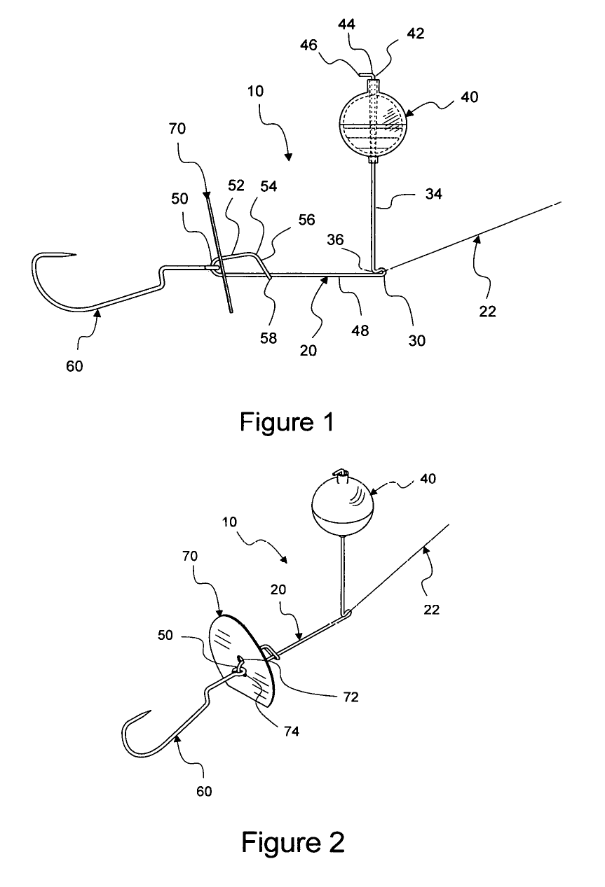

Reference is now made to the embodiments illustrated in FIGS. 1-7 wherein like numerals are used to designate like parts throughout. Primes of numbers designate labeled lure parts which are similar in form and function, but not identical, to parts numbered without primes.

Reference is now made to FIGS. 1-3, wherein a fishing lure 10 made according to the present invention for near surface fishing is seen. Lure 10 comprises a wire frame 20 (although a frame can be made with other materials, such as molded plastic or stamped steel). Frame 20 comprises a plurality of bends and segments, which comprise a fishing line 22 attachment site 30 (One skilled in the art will recognize that site 30 may comprise a closed loop, not shown). A horizontal plane (not shown) determined by the level of attachment of line 22 is mentioned for future reference.

Away from attachment site 30, a segment 34 of frame 20 is directed upward at a bend 36 to provide an upwardly distending segment about which a bobber 40 is slideably affixed. At the upward end 42 of segment 34, frame further comprises a bend 44 to form a retaining segment 46 which is used to securely affix bobber 40 about segment 34. So affixed, bobber 40 determines frame 20 orientation and depth in water.

Aft from site 30 frame 20 comprises a segment 48 which continues to a “U” bend 50 from which a segment 52 continues forward to a downward bend 54. Extending from bend 54, frame is continued downward along segment 56 to a final bend 58 which is used to form a clasp 58 about segment 48. As better seen in FIG. 2, a fishhook 60 can be loosely affixed about frame 20 at bend 50. Further, a blade 70 comprises a pair of holes 72 and 74 through which segments 52 and 54 are threaded to affix blade 70 to frame 10 and by geometric relationship with hole 72 and 74 disposition and relative angulation between segments 48 and 52 determine an angle of attack of blade 70 when drawn through water. In combination, flotation of bobber 40 and blade 70 motion due to force on line 22 determines lure depth and fish attracting action. As disclosed in detail in U.S. Patent Applications from which is Application continues-in-part, blade 70 action comprises at least two oscillatory modes, a more vertical side-to-side oscillation and a yaw about a medial axis of the blade and frame. This action produces a varying wake which acts to formulate a natural swimming action of a following fishhook assembly.

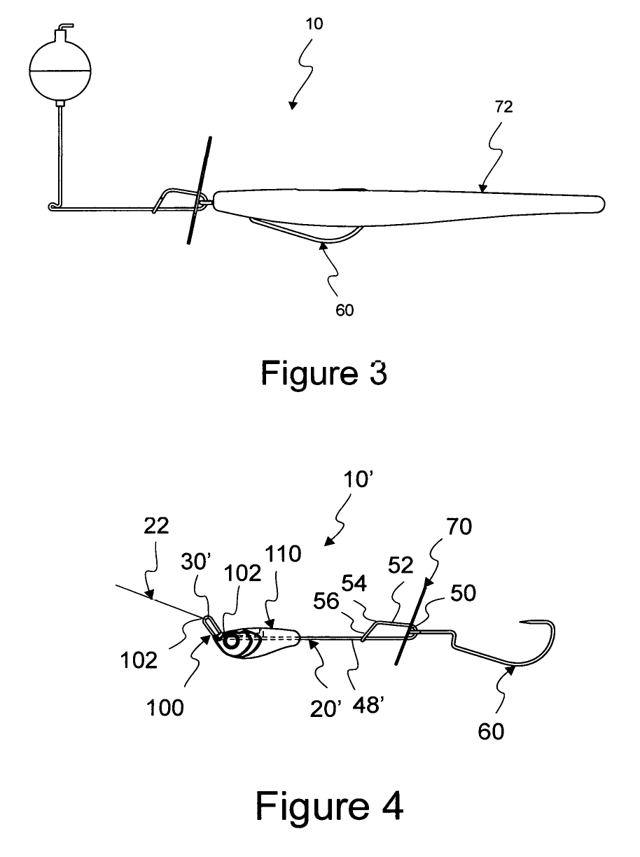

As seen in FIG. 3, fishhook 60 can be used for attaching a bait 72 (either natural or artificial) as is well known to those who are skilled in the use of fishing lures. Preferably, bobber 40 is made to be variably filled and of transparent plastic, although bobber 40 may be replaced by a mass of cork, styrofoam or other floating material. Frame 20 is preferred to be made from 0.032 gauge stainless steel wire. Blade 70 is also preferably formed from transparent plastic material, but may also be manufactured from brass, titanium or stainless steel.

Reference is now made to FIGS. 4-7 wherein another embodiment of a fishing lure 10′ made according the present invention is seen. As seen in FIG. 4, fishing lure 10′ comprises a frame 20′, the aft portion of which can be identical to frame 20, seen in FIGS. 1-3. However, a forward portion 100 of frame 20′ comprises a superiorly directed bend 102 (seen as hidden (dashed) lines) disposed within an over-molded weight 110. Note that weight 110 is disposed below a horizontal plane through a fishing line attachment site 30′ formed by a bend 112 in forward portion 100.

As mentioned supra, weight 110 is preferably over-molded about segment 48′. However, affixing a threaded weight to segment 48′ as weight is disposed is within the scope of the present invention. Weight may be made of any material which is safe to handle and which has a correct mass range to vertically orient lure 10′ and determine desired fishing depth at a predetermined velocity when lure 10′ is drawn through water.

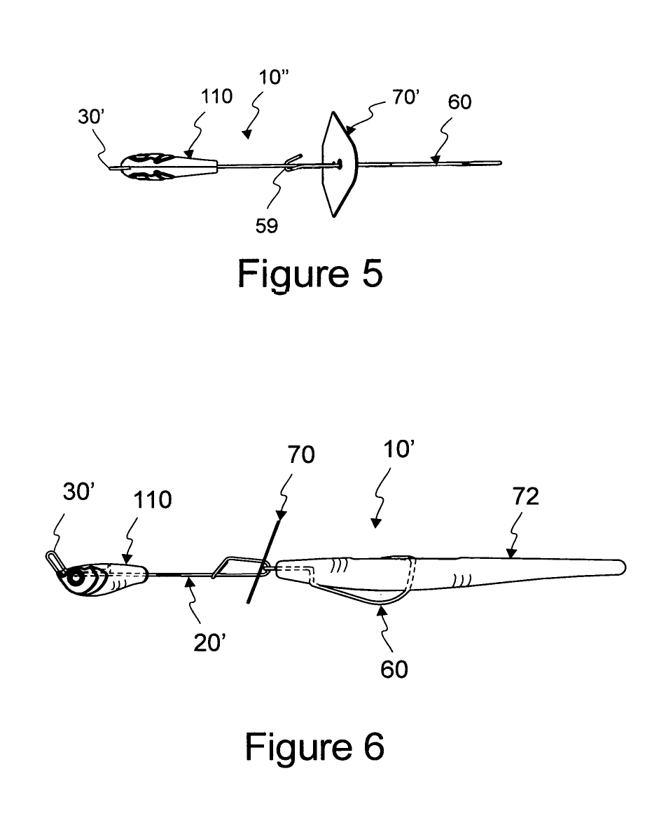

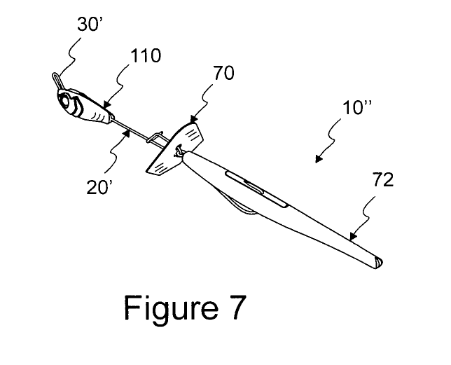

A better view of lure 10′ alignment is seen in FIG. 5. Also, clasp 58 is better seen in FIG. 5. Similar to lure 10, as seen in FIG. 3, a bait 72 is affixed to hook 60 in lure 10″, as seen in FIG. 6. Lures 10′ and 10″ are the seam except for difference in shape of blades 70 and 70′. For clarification, fishing lure 10″ comprises a blade 70′ having a non-uniform pentagonal shape for better fishing in deeper water, as seen in FIGS. 6 and 7. (Other blade 70′ shapes will be obvious to one skilled in the art, not shown.)

1. A bladed fishing lure comprising features for determining lure running depth, said fishing lure comprising:
a fishing lure frame comprising a plurality of bends and substantially straight segments between said bends to thereby provide (1) a lure blade stabilizer which determines angle of attack of a lure blade when displaced through water, (2) segments which are displaced through the blade to securely, but loosely affix the blade to the frame, (3) a site forward of the blade where a fishing line is affixed, (4) a section aft of the fishing line connecting site and forward of the blade where a fishing depth determining mass is securely affixed, (5) a fishhook attachment site which provides a connection for a fishhook assembly;
the stabilizing mass comprising a mass selected from a variety of masses comprising buoyant masses and heavier than water masses and affixed to the frame at a site which provides a stabilizing influence upon the lure and which is a determining factor in lure fishing depth;
a blade formed and shaped to yaw and oscillate when drawn through the water affixed to said frame, said blade further comprising hole structure through which at least one frame segment is displaced to affix said blade to said frame; and
a fishhook assembly disposed aft of the blade and thereat affixed to the fishhook attachments site.

2. A bladed fishing lure according to claim 1 wherein said stabilizing mass is a mass having less density than water affixed to a segment of said frame to stabilize said frame by upward force.

3. A bladed fishing lure according to claim 2 wherein said stabilizing mass is a bobber.

4. A bladed fishing lure according to claim 1 wherein said stabilizing mass is a mass having greater density than water being affixed to a segment of said frame comprising a bend to thereby disposed said stabilizing mass inferior to said affixing line site for stabilizing said frame by downward force and comprising a weight which selectively lowers said lure to a predetermined fishing depth at a predetermined lure velocity when drawn through water.

5. A bladed fishing lure according to claim 1 wherein said fishing lure frame comprises a single wire.

6. A bladed fishing lure comprising features for determining lure running depth, said fishing lure comprising:
a fishing lure frame comprising a plurality of bends and substantially straight segments between said bends to thereby provide (1) a lure blade stabilizer which determines angle of attack of a lure blade when displaced through water, (2) segments which are displaced through the blade to securely, but loosely affix the blade to the frame, (3) a site forward of the blade where a fishing line is affixed, (4) a section displaced by at least one bend from the fishing line connecting site which is forward of the blade by which a buoyant mass is securely affixed for near-surface fishing, (5) a fishhook attachment site which provides a connection for a fishhook assembly;
the buoyant mass affixed to the frame at a site which provides a stabilizing influence upon the lure and which is a determining factor in shallow lure fishing depth;
a blade formed and shaped to yaw and oscillate when drawn through the water affixed to said frame, said blade further comprising hole structure through which at least one frame segment is displaced to affix said blade to said frame; and
a fishhook assembly disposed aft of the blade and thereat affixed to the fishhook attachments site.

7. A bladed fishing lure comprising features for determining lure running depth, said fishing lure comprising:
a fishing lure frame comprising a plurality of bends and substantially straight segments between said bends to thereby provide (1) a lure blade stabilizer which determines angle of attack of a lure blade when displaced through water, (2) segments which are displaced through the blade to securely, but loosely affix the blade to the frame, (3) a site forward of the blade where a fishing line is affixed, (4) a section of the frame having a heavier than water depth determining mass securely affixed forward of the blade, (5) a fishhook attachment site which provides a connection for a fishhook assembly;
a stabilizing mass comprising a mass selected from masses that are heavier than water and affixed to the frame inferior to the fishing line affixing site and forward of the blade thereby providing a stabilizing influence upon the lure and a determining factor in lure fishing depth;
a blade formed and shaped to yaw and oscillate when drawn through the water affixed to said frame, said blade further comprising hole structure through which at least one frame segment is displaced to affix said blade to said frame; and
a fishhook assembly disposed aft of the blade and thereat affixed to the fishhook attachments site.
